(19) United States
(12) Patent Application Publication
(10) Pub. No.: US 2024/0304201 A1
(43) Pub. Date: Sep. 12, 2024

(54) AUDIO-BASED PROCESSING METHOD AND APPARATUS

(71) Applicant: Shenzhen Horizon Robotics Technology Co., Ltd., Guangdong (CN)

(72) Inventor: Guangwei CHENG, Guangdong (CN)

(73) Assignee: Shenzhen Horizon Robotics Technology Co., Ltd., Guangdong (CN)

(21) Appl. No.: 18/260,120

(22) PCT Filed: Aug. 19, 2022
(86) PCT No.: PCT/CN2022/113733

§ 371 Date: Jun. 30, 2023

(30) Foreign Application Priority Data
Aug. 20, 2021 (CN) 202110959350.0

(51) Int. Cl. G10L 21/0208; G10L 15/22; G10L 21/0216

(52) U.S. Cl. CPC G10L 21/0208; G10L 2015/227; G10L 2021/02082; G10L 2021/02166

(57) ABSTRACT

Disclosed are an audio-based processing method and apparatus. The processing method includes: extracting a target acoustic source signal from a mixed audio signal collected through a microphone array (S1); recognizing text content corresponding to the target acoustic source signal from the target acoustic source signal (S2); determining a target loudspeaker based on the text content (S3); controlling the target loudspeaker to play a speech corresponding to the target acoustic source signal (S4); and performing echo cancellation for a loudspeaker in a sound region to which the target acoustic source signal belongs based on a position of the target loudspeaker, a position of the loudspeaker in the sound region to which the target acoustic source signal belongs, and a volume of speech for playback through the target loudspeaker (S5).

The present application claims priority to Chinese patent application No. 202110959350.0, filed with the China National Intellectual Property Administration on Aug. 20, 2021 and entitled “AUDIO-BASED PROCESSING METHOD AND APPARATUS”, disclosure of which is incorporated herein by references in its entirety.

### FIELD OF THE INVENTION

The present disclosure relates to the technical field of vehicles and the technical field of audio processing, and in particular, to an audio-based processing method and apparatus.

### BACKGROUND OF THE INVENTION

During high-speed driving of a vehicle, noise in the vehicle may seriously affect hearing of a person in the vehicle. Especially for a driver, strong noise may distract attention of the driver and affect driving safety.

In related technologies, noise can be reduced to a certain extent through signal collection and noise reduction. However, prior noise reduction manners are to suppress wind noise and tire noise. When there are a plurality of persons chatting in the vehicle, a signal played through a loudspeaker is a mixed signal of multi-person voices, and a listener can hear own voice through the loudspeaker, resulting in poor user experience.

### SUMMARY OF THE INVENTION

To resolve the foregoing technical problem, embodiments of the present disclosure provide an audio-based processing method and apparatus.

According to a first aspect of an embodiment of the present disclosure, an audio-based processing method is provided, including:
extracting a target acoustic source signal from a mixed audio signal collected through a microphone array;
recognizing text content corresponding to the target acoustic source signal from the target acoustic source signal;
determining a target loudspeaker based on the text content;
controlling the target loudspeaker to play a speech corresponding to the target acoustic source signal; and
performing echo cancellation for a loudspeaker in a sound region to which the target acoustic source signal belongs based on a position of the target loudspeaker, a position of the loudspeaker in the sound region to which the target acoustic source signal belongs, and a volume of speech for playback through the target loudspeaker.

According to a second aspect of an embodiment of the present disclosure, an audio-based processing apparatus is provided, including:
an acoustic source signal extraction module, configured to extract a target acoustic source signal from a mixed audio signal collected through a microphone array;
an acoustic source signal recognition module, configured to recognize text content corresponding to the target acoustic source signal from the target acoustic source signal;
a target loudspeaker determination module, configured to determine a target loudspeaker based on the text content;
a control module, configured to control the target loudspeaker to play a speech corresponding to the target acoustic source signal; and
an echo cancellation module, configured to perform echo cancellation for a loudspeaker in a sound region to which the target acoustic source signal belongs based on a position of the target loudspeaker, a position of the loudspeaker in the sound region to which the target acoustic source signal belongs, and a volume of speech for playback through the target loudspeaker.

According to a third aspect of an embodiment of the present disclosure, a computer readable storage medium is provided, in which a computer program is stored, wherein the computer program is used for implementing the audio-based processing method according to the first aspect.

According to a fourth aspect of an embodiment of the present disclosure, an electronic device is provided, where the electronic device includes:
a processor; and
a memory, configured to store a processor-executable instruction, where
the processor is configured to read the executable instruction from the memory, and execute the instruction to implement the audio-based processing method according to the first aspect.

According to the audio-based processing method and apparatus provided in the foregoing embodiments of the present disclosure, the target acoustic source signal is extracted from the mixed audio signal collected through the microphone array; and then the text content corresponding to the target acoustic source signal is recognized from the target acoustic source signal; and subsequently, the target loudspeaker required for use is determined based on the text content. Further, on one hand, the target loudspeaker is controlled to play the speech corresponding to the target acoustic source signal, to achieve smooth communication between persons in a vehicle at a high-speed driving state; and on the other hand, echo cancellation is performed for the loudspeaker in the sound region to which the target acoustic source signal belongs based on the position of the target loudspeaker, the position of the loudspeaker in the sound region to which the target acoustic source signal belongs, and the volume of the speech, so that a voice of a speaking person can be prevented from being played through the loudspeaker in a sound region to which the speaking person belongs, thereby improving user experience.

The technical solutions of the present disclosure are further described below in detail with reference to the accompanying drawings and the embodiments.

### BRIEF DESCRIPTION OF THE DRAWINGS

By describing the embodiments of the present disclosure more detailed with reference to the accompanying drawings, the foregoing and other objectives, features, and advantages of the present disclosure will become more apparent. The accompanying drawings are provided, as a part of the specification, for further understanding of the embodiments of the present disclosure and for explaining the present disclosure together with the embodiments of the present disclosure, and are not intended to limit the present disclosure. Throughout the accompanying drawings, same reference signs generally refer to same components or steps.

FIG. 1 is a schematic flowchart of an audio-based processing method according to an embodiment of the present disclosure;

FIG. 2 is a structural block diagram of an audio-based processing apparatus according to an embodiment of the present disclosure;

FIG. 3 is a structural block diagram of an echo cancellation module 250 according to an embodiment of the present disclosure;

FIG. 4 is a structural block diagram of an acoustic source signal extraction module 210 according to an embodiment of the present disclosure;

FIG. 5 is a structural block diagram of a target loudspeaker determination module 230 according to an embodiment of the present disclosure; and

FIG. 6 is a structural diagram of an electronic device according to an exemplary embodiment of the present disclosure.

### DETAILED DESCRIPTION OF THE EMBODIMENTS

Exemplary embodiments of the present disclosure are described below in detail with reference to the accompanying drawings. Obviously, the described embodiments are merely a part, rather than all of embodiments of the present disclosure. It should be understood that the present disclosure is not limited by the exemplary embodiments described herein.

It should be noted that unless otherwise specified, the scope of the present disclosure is not limited by relative arrangement, numeric expressions, and numerical values of components and steps described in these embodiments.

A person skilled in the art may understand that terms such as “first” and “second” in the embodiments of the present disclosure are intended to merely distinguish between different steps, devices, or modules, and indicate neither any particular technical meaning, nor necessarily logical ordering among them.

It should be further understood that, in the embodiments of the present disclosure, the term “multiple”/“a plurality of” may refer to two or more; and the term “at least one” may refer to one, two, or more.

The embodiments of the present disclosure can be applicable to a terminal device, a computer system, a server, and other electronic devices, which can be operated together with numerous other general-purpose or special-purpose computing system environments or configurations. Well-known examples of a terminal device, a computing system, and environment and/or configuration applicable to be used with the terminal device, the computer system, the server, and other electronic devices include but are not limited to: a personal computer system, a server computer system, a thin client, a thick client, a handheld or laptop device, a microprocessor-based system, a set-top box, programmable consumer electronics, a network personal computer, a small computer system, a mainframe computer system, and a distributed cloud computing technology environment including any of the foregoing systems.

### Exemplary Method

FIG. 1 is a schematic flowchart of an audio-based processing method according to an embodiment of the present disclosure. This embodiment can be applied to an electronic device. As shown in FIG. 1, the method includes the following steps.

S1. Extract a target acoustic source signal from a mixed audio signal collected through a microphone array.

Specifically, a microphone array is provided in a vehicle, and acoustic source signals of passengers in all seats can be collected through the microphone array. A microphone and a loudspeaker are provided for each seat. Taking a vehicle with five seats in two rows as an example, the microphone array includes five microphones that are respectively disposed for a driver seat, a front passenger seat, a rear left passenger seat, a rear middle passenger seat, and a rear right passenger seat. Each microphone belongs to a fixed sound region. For example, the microphone for the driver seat belongs to a sound region of the driver seat, the microphone for the front passenger seat belongs to a sound region of the front passenger seat, and so on.

After the mixed audio signal including noise and voice from at least one person is collected through the microphone array, the target acoustic source signal, such as a speech signal of a passenger, can be extracted from the mixed audio signal by processing the mixed audio signal. If only one person speaks during a certain time period (for example, for 5 seconds), the mixed audio signal collected through the microphone array includes only noise and an acoustic source signal of this person. If a plurality of persons speak during this time period, the mixed audio signal during this time period includes noise and acoustic source signals of the plurality of persons, and the target acoustic source signal needs to be extracted from the acoustic source signals of the plurality of persons. Moreover, the same processing is performed on each remaining acoustic source signal other than the target acoustic source signal according to the following steps (to be specific, steps S2 to S5).

S2. Recognize text content corresponding to the target acoustic source signal from the target acoustic source signal.

Specifically, recognition is performed on the target acoustic source signal by an audio recognition technology to obtain the text content corresponding to the target acoustic source signal.

S3. Determine a target loudspeaker based on the text content.

Specifically, text processing is performed on the text content, such as word segmentation. In this way, a noun, a verb, an adjective, and the like in each sentence can be obtained. Because the text content usually contains words that can be used to determine a chat object, words involving the chat object can be determined after the text processing is performed on the text content. Further, a loudspeaker corresponding to the chat object can be determined, and the loudspeaker is used as the target loudspeaker.

S4. Control the target loudspeaker to play a speech corresponding to the target acoustic source signal.

S5. Perform echo cancellation for a loudspeaker in a sound region to which the target acoustic source signal belongs based on a position of the target loudspeaker, a position of the loudspeaker in the sound region to which the target acoustic source signal belongs, and a volume of the speech.

Specifically, position information of each loudspeaker is pre-stored in an in-vehicle audio system, and the in-vehicle audio system measures and models actual sound production of each position in the vehicle, to calculate and obtain an optimal cancellation function for each position. Based on a position of a loudspeaker in a sound region to which a speaking person belongs (that is, the position of the loudspeaker in the sound region to which the target acoustic source signal belongs), a position of a loudspeaker in a sound region to which the chat object belongs (that is, the position of the target loudspeaker), and the volume of speech for playback, an cancellation signal for canceling out audio of the speaking person is generated through the optimal cancellation function. A voice of the speaking person from the loudspeaker in the sound region to which the speaking person belongs can be canceled out based on the cancellation signal.

In this embodiment, the target acoustic source signal is extracted from the mixed audio signal collected through the microphone array; and then the text content corresponding to the target acoustic source signal is recognized from the target acoustic source signal; and subsequently, the target loudspeaker required for use is determined based on the text content. Further, on one hand, the target loudspeaker is controlled to play a speech corresponding to the text content, to achieve smooth communication between persons in the vehicle at high-speed driving; and on the other hand, echo cancellation is performed for the loudspeaker in the sound region to which the target acoustic source signal belongs based on the position of the target loudspeaker, the position of the loudspeaker in the sound region to which the target acoustic source signal belongs, and the volume of the speech, so that a voice of a speaking person can be prevented from being played through the loudspeaker in the sound region to which the speaking person belongs, thereby improving user experience.

In an embodiment of the present disclosure, step S5 includes the following steps.

S5-1. Acquire a position of an auditory organ in a space of a person from who the target acoustic source signal is generated.

In an example of the present disclosure, a camera for capturing in-vehicle videos or images is provided in the vehicle. Based on the image captured by the camera and parameters of the camera, the position of the auditory organ in the space of the person from who the target acoustic source signal is generated, i.e., a position of an ear of the speaking person, can be determined through image analysis. The parameters of the camera include a focal length, resolution, and other parameters of the camera.

In another example of the present disclosure, a radar is provided in the vehicle. The position of the auditory organ in the space of the person from who the target acoustic source signal is generated can be determined by analyzing point cloud data obtained through scanning by the radar.

S5-2. Perform echo cancellation for the loudspeaker in the sound region to which the target acoustic source signal belongs based on the position of the auditory organ in the space of the person from who the target acoustic source signal is generated, the position of the target loudspeaker, the position of the loudspeaker in the sound region to which the target acoustic source signal belongs, and the volume of the speech.

Specifically, a distance between the loudspeaker and the ear of the person can be calculated based on the position of the ear of the person and the position of the loudspeaker in the sound region to which the speaking person belongs. When the optimal cancellation function is used, based on the distance between the loudspeaker and the ear of the person, the position of the loudspeaker in the sound region to which the chat object belongs (that is, the position of the target loudspeaker), and the volume of speech for playback, an optimal cancellation signal for canceling out the audio of the speaking person is generated through the optimal cancellation function. The voice of the speaking person from the loudspeaker in the sound region to which the speaking person belongs can be canceled out to the greatest extent based on the optimal cancellation signal.

In this embodiment, a distance between the speaking person and the loudspeaker can be determined by acquiring the position of the auditory organ in the space of the speaking person and a position of a loudspeaker for the speaking person. The cancellation signal can be dynamically adjusted based on a real-time distance, so that the voice of the speaking person from the loudspeaker in the sound region to which the speaking person belongs can be canceled out to the greatest extent.

In an embodiment of the present disclosure, step S1 includes the following steps.

S1-1. Detect whether there is a person sitting in each of seats in a vehicle.

Specifically, it can be determined, in a manner of image recognition, infrared detection, seat weight detection, or the like, whether there is a person sitting in each of seats in the vehicle.

S1-2. Perform voice separation on the target audio signal based on a sound region to which a microphone corresponding to a seat occupied by a person belongs, and extract the target acoustic source signal based on a voice separation result, where the microphone array includes microphones located at all seats in the vehicle.

Specifically, after the voice separation is performed only for the microphone corresponding to the seat occupied by a person, tire noise suppression and wind noise suppression are performed to finally obtain the target acoustic source signal. In this embodiment, a voice separation model can be trained through a plurality of acoustic source signals. For example, the voice separation model is trained through acoustic source signals of persons who often take the vehicle, and effective voice separation can be performed based on the trained voice separation model. In this embodiment, a dynamic gain control function for suppression based on dynamic tire noise and wind noise is provided in advance, and real-time tire noise and wind noise are suppressed based on the dynamic gain control function.

In this embodiment, the voice separation is performed only for the microphone with a person in the seat, which can improve efficiency of voice separation and reduce system resource consumption. In addition, real-time tire noise suppression and wind noise suppression can be performed through the dynamic gain control function. After voice separation, tire noise suppression, and wind noise suppression are performed, the target acoustic source signal can be accurately extracted.

In an embodiment of the present disclosure, step S3 includes the following steps.

S3-1. Extract a keyword from the text content. The keyword in the text content can be extracted by performing word segmentation and keyword extraction on the text content.

S3-2. Match the keyword in the text content with a plurality of preset keywords. Each keyword of the plurality of preset keywords corresponds to a corresponding loudspeaker.

S3-3. Determine the target loudspeaker based on a matching result. For example, for a loudspeaker A, corresponding preset keywords include A1, A2, and A3. If the text content includes any one of the keywords A1, A2, and A3, it can be determined that the loudspeaker A is the target loudspeaker. For another loudspeaker, corresponding preset keywords are also provided accordingly.

In this embodiment, by matching the keyword in the text content with a plurality of preset keywords, the target loudspeaker can be determined quickly and accurately based on the matching result.

In an embodiment of the present disclosure, step S3-3 includes the following steps.

S3-3-1. Establish a correspondence relationship between at least two loudspeakers and the plurality of preset keywords. The at least two loudspeakers include a loudspeaker corresponding to the sound region to which the target acoustic source signal belongs.

Specifically, the at least two loudspeakers include the loudspeaker for the speaking person and the loudspeaker for the chat object. Optionally, correspondence relationships between all loudspeakers and corresponding keywords are established in advance. For example, if five loudspeakers are disposed for a vehicle with five seats, correspondence relationships between the five loudspeakers and corresponding preset keywords can be established in advance.

S3-3-2. Match each keyword of the plurality of preset keywords with the keyword in the text content to obtain a matching result between the at least two loudspeakers and the text content.

S3-3-3. Determine the target loudspeaker based on the matching result and the correspondence relationship.

In this embodiment, correspondence relationships may be established only between some of the loudspeakers in the vehicle and the preset keywords. If the keyword in the text content matches with one of a plurality of preset keywords successfully, it indicates that a speaking person of the acoustic source signal has a specified chat object. In this case, a loudspeaker corresponding to the successfully matched preset keyword is used as the target loudspeaker. If the keyword in the text content fails to match with all keywords in the plurality of preset keywords, it indicates that the speaking person of the acoustic source signal does not have a specified chat object. In this case, any loudspeaker with a person sitting in the seat or all loudspeakers can be used as the target loudspeaker.

In an embodiment of the present disclosure, step S3-3-1 includes the following steps.

S3-3-1-1. Establish a first matching relationship between the at least two target seats and the plurality of preset keywords, and/or establish a second matching relationship between persons in the at least two target seats and the plurality of keywords, where the at least two target seats are in one-to-one correspondence to the at least two loudspeakers.

Specifically, the target seat can be bound to the preset keyword, or the person in the target seat can be bound to the preset keyword. When binding the person in the target seat to the preset keyword, a name, an alias, or a code name of the person on the target seat can be bound to the preset keyword. For example, an alias “Lao San” is bound to a designated person.

S3-3-1-2. Establish the correspondence relationship between the at least two loudspeakers and the plurality of preset keywords based on the first matching relationship and/or the second matching relationship.

Specifically, the correspondence relationship between the at least two loudspeakers and the plurality of preset keywords can be established based on the first matching relationship. For example, a correspondence relationship can be established between a loudspeaker at the driver seat and keywords such as “driver seat” and “driver”. For example, a correspondence relationship can also be established between a loudspeaker at the front passenger seat and keywords such as “front passenger seat” and “front passenger”.

In addition, the correspondence relationship can also be established between the at least two loudspeakers and the plurality of preset keywords based on the second matching relationship. For example, a person with the alias “Lao San” is sitting in the rear left passenger seat, and after a seating position of the person with the alias “Lao San” is determined through image recognition and other manners, a correspondence relationship can be established between the loudspeaker in the rear left passenger seat and the keyword “Lao San”. Moreover, a correspondence relationship can be established between the loudspeaker in the left passenger seat and a real name of “Lao San”.

In this embodiment, a matching relationship can be established between a seat, a person name, an alias, or a code name and the loudspeaker, to serve as the correspondence relationship between the loudspeaker and the preset keyword. When a preset keyword in the matching relationship appears in the keyword of the text content corresponding to the target acoustic source signal, the target loudspeaker and chat object can be determined quickly and accurately.

In an embodiment of the present disclosure, the audio-based processing method further includes: when target-type audio is played through a specified loudspeaker, noise reduction is performed for a remaining loudspeaker other than the specified loudspeaker based on a position of the specified loudspeaker, a position of the remaining loudspeaker, and a volume of target audio.

In this embodiment, the target-type audio includes output audio when a passenger performs human-machine interaction, listens to music, or watches a movie. When a passenger performs human-machine interaction, listens to music, or watches a movie, noise reduction can be performed based on an audio playback volume of a loudspeaker for the passenger, a position of the loudspeaker for the passenger, and a position of a loudspeaker in need of noise reduction (for example, a loudspeaker at a position where there is a person in the seat and the person does not want to be disturbed).

In an embodiment of the present disclosure, after step S5, the method further includes:

S6: If a preset chat ending keyword is recognized from the mixed audio signal collected through the microphone array, turn off a loudspeaker to which an acoustic source signal corresponding to the chat ending keyword belongs.

In this embodiment, if it is detected that a preset chat ending keyword (such as “chatting is over” or “no more talking”) is spoken during chatting in the vehicle, it indicates that the person does not want to continue chatting. In this case, a loudspeaker for this person is turned off to prevent the person from being disturbed by other persons during chatting (for example, someone chatting with an aimless object).

Any audio-based processing method provided in the embodiments of the present disclosure can be implemented by any suitable device with a data processing capability, including but not limited to a terminal device and a server. Alternatively, any audio-based processing method provided in the embodiments of the present disclosure can be implemented by a processor. For example, the processor implements any audio-based processing method described in the embodiments of the present disclosure by invoking a corresponding instruction stored in a memory. Details are not described below again.

### Exemplary Device

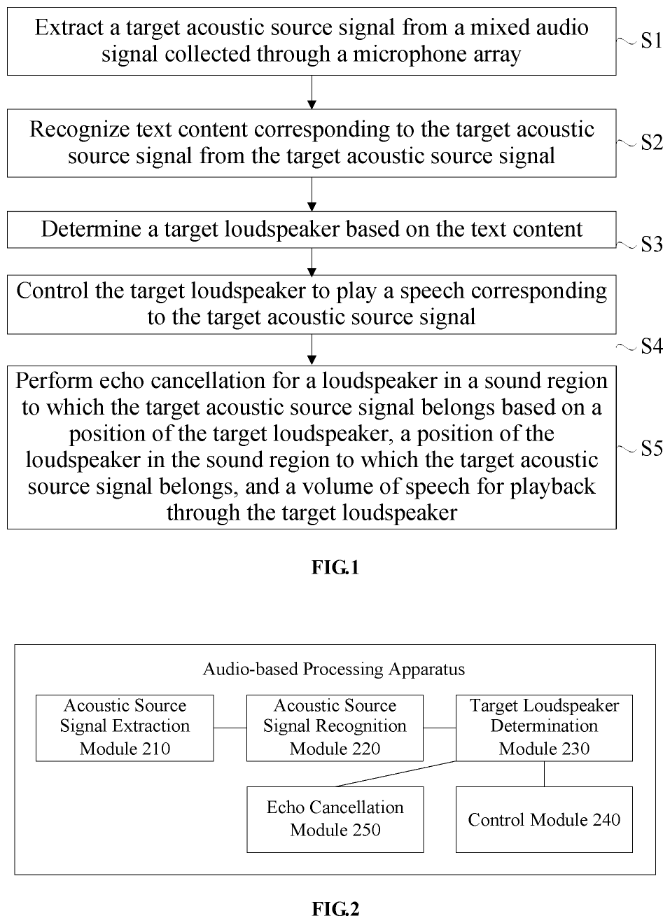

FIG. 2 is a structural block diagram of an audio-based processing apparatus according to an embodiment of the present disclosure. As shown in FIG. 2, the audio-based processing apparatus in this embodiment of the present disclosure includes an acoustic source signal extraction module 210, an acoustic source signal recognition module 220, a target loudspeaker determination module 230, a control module 240, and an echo cancellation module 250.

The acoustic source signal extraction module 210 is configured to extract a target acoustic source signal from a mixed audio signal collected through a microphone array.

The acoustic source signal recognition module 220 is configured to recognize text content corresponding to the target acoustic source signal from the target acoustic source signal.

The target loudspeaker determination module 230 is configured to determine a target loudspeaker based on the text content.

The control module 240 is configured to control the target loudspeaker to play a speech corresponding to the target acoustic source signal.

The echo cancellation module 250 is configured to perform echo cancellation for a loudspeaker in a sound region to which the target acoustic source signal belongs based on a position of the target loudspeaker, a position of the loudspeaker in the sound region to which the target acoustic source signal belongs, and a volume of speech for playback through the target loudspeaker.

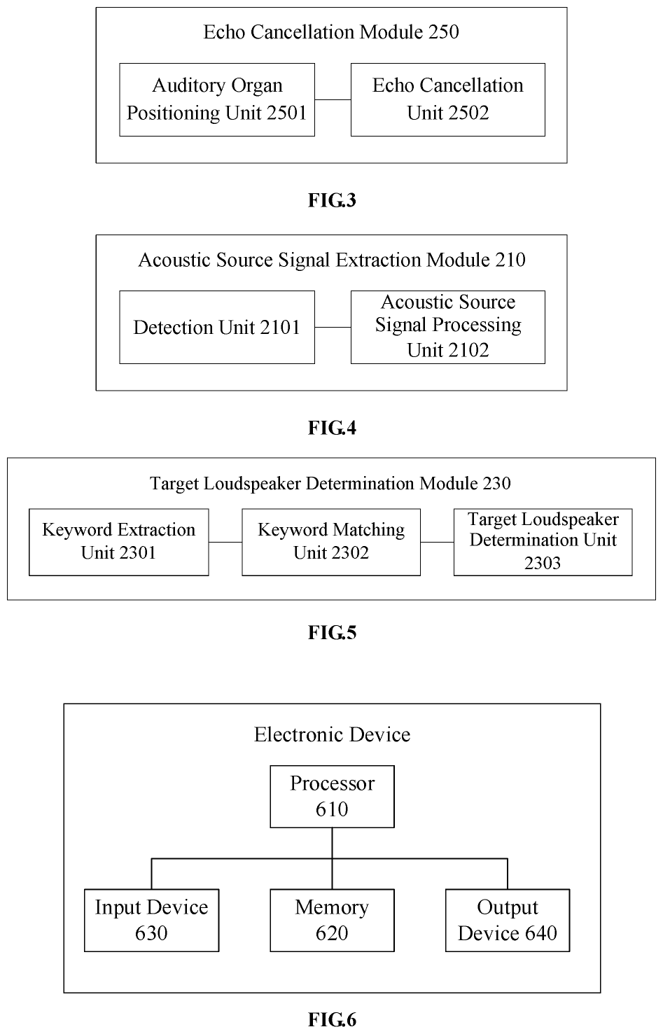

FIG. 3 is a structural block diagram of an echo cancellation module 250 according to an embodiment of the present disclosure. As shown in FIG. 3, in an embodiment of the present disclosure, the echo cancellation module 250 includes:
an auditory organ positioning unit 2501, configured to acquire a position of an auditory organ in a space of a person from who the target acoustic source signal is generated; and
an echo cancellation unit 2502, configured to perform echo cancellation for the loudspeaker in the sound region to which the target acoustic source signal belongs based on the position of the auditory organ in the space of the person from who the target acoustic source signal is generated, the position of the target loudspeaker, the position of the loudspeaker in the sound region to which the target acoustic source signal belongs, and a volume of the speech.

FIG. 4 is a structural block diagram of an acoustic source signal extraction module 210 according to an embodiment of the present disclosure. As shown in FIG. 4, in an embodiment of the present disclosure, the acoustic source signal extraction module 210 includes:
a detection unit 2101, configured to detect whether there is a person sitting in each of seats in a vehicle; and
an acoustic source signal processing unit 2102, configured to perform voice separation on the target audio signal based on a sound region to which a microphone corresponding to a seat occupied by a person belongs, and extract the target acoustic source signal based on a voice separation result, where the microphone array includes microphones located at all seats in the vehicle.

FIG. 5 is a structural block diagram of a target loudspeaker determination module 230 according to an embodiment of the present disclosure. As shown in FIG. 5, in an embodiment of the present disclosure, the target loudspeaker determination module 230 includes:
a keyword extraction unit 2301, configured to extract a keyword from the text content;
a keyword matching unit 2302, configured to match the keyword in the text content with a plurality of preset keywords; and
a target loudspeaker determination unit 2303, configured to determine the target loudspeaker based on a matching result.

In an embodiment of the present disclosure, the target loudspeaker determination unit 2303 is configured to establish a correspondence relationship between at least two loudspeakers and the plurality of preset keywords, where the at least two loudspeakers include a loudspeaker corresponding to the sound region to which the target acoustic source signal belongs.

The target loudspeaker determination unit 2303 is further configured to match each keyword of the plurality of preset keywords with the keyword in the text content to obtain a matching result between the at least two loudspeakers and the text content.

The target loudspeaker determination unit 2303 is further configured to determine the target loudspeaker based on the matching result and the correspondence relationship.

In an embodiment of the present disclosure, the target loudspeaker determination unit 2303 is configured to establish a first matching relationship between the at least two target seats and the plurality of preset keywords, and/or establish a second matching relationship between persons in the at least two target seats and the plurality of keywords, where the at least two target seats are in one-to-one correspondence to the at least two loudspeakers.

The target loudspeaker determination unit 2303 is further configured to establish a correspondence relationship between the least two loudspeakers and the plurality of preset keywords based on the first matching relationship and/or the second matching relationship.

In an embodiment of the present disclosure, the control module 240 is further configured to perform, when target-type audio is played through a specified loudspeaker, noise reduction for a remaining loudspeaker other than the specified loudspeaker based on a position of the specified loudspeaker, a position of the remaining loudspeaker, and a volume of target audio.

It should be noted that the specific implementations of the audio-based processing apparatus in the embodiments of the present disclosure are similar to the specific implementations of the audio-based processing method in the embodiments of the present disclosure. For details, reference can be made to the section of audio-based processing method. To reduce redundancy, details are not described again.

### Exemplary Electronic Device

An electronic device according to an embodiment of the present disclosure is described below with reference to FIG. 6.

FIG. 6 shows a block diagram of an electronic device according to an embodiment of the present disclosure. As shown in FIG. 6, an electronic device 10 includes one or more processors 610 and a memory 620.

The processor 610 may be a central processing unit (CPU) or another form of processing unit having a data processing capability and/or an instruction execution capability, and can control another component in the electronic device to perform a desired function.

The memory 620 can include one or more computer program products. The computer program product can include various forms of computer readable storage media, such as a volatile memory and/or a non-volatile memory. The volatile memory can include, for example, a random access memory (RAM) a cache, and/or the like. The nonvolatile memory can include, for example, a read-only memory (ROM), a hard disk, a flash memory, and the like. One or more computer program instructions can be stored on the computer readable storage medium. A processor 11 can execute the program instruction to implement the audio-based processing method according to various embodiments of the present disclosure that are described above and/or other desired functions. Various contents such as an input signal, a signal component, and a noise component can also be stored in the computer readable storage medium.

In an example, the electronic device can further include an input device 630 and an output device 640, which are connected with each other through a bus system and/or another form of connection mechanism (not shown).

In addition, the input device 630 can further include, for example, a keyboard a mouse, and the like.

The output device 640 can include, for example, a display, a loudspeaker, a printer, a communication network, and a remote output device connected through the communication network.

Certainly, for simplicity, FIG. 6 shows only some of components in the electronic device that are related to the present disclosure, and components such as a bus and an input/output interface are omitted. In addition, according to specific application situations, the electronic device can further include any other appropriate components.

### Exemplary Computer Program Product and Computer Readable Storage Medium

In addition to the foregoing method and device, the embodiments of the present disclosure can also relate to a computer program product, which includes computer program instructions. When the computer program instructions are run by a processor, the processor is enabled to perform the steps, of the audio-based processing method according to the embodiments of the present disclosure, that are described in the “exemplary method” part of this specification.

Basic principles of the present disclosure are described above in combination with specific embodiments. However, it should be pointed out that the advantages, superiorities, and effects mentioned in the present disclosure are merely examples but are not for limitation, and it cannot be considered that these advantages, superiorities, and effects are necessary for each embodiment of the present disclosure. In addition, specific details described above are merely for examples and for ease of understanding, rather than limitations. The details described above do not limit that the present disclosure must be implemented by the foregoing specific details.

The various embodiments in this specification are all described in a progressive way, and the description of each embodiment focuses on a difference from other embodiments. For same or similar parts among the various embodiments, reference can be made to each other. The system embodiments basically correspond to the method embodiments, and thus are relatively simply described. For related parts, reference can be made to a part of the descriptions of the method embodiments.

The block diagrams of the equipment, the apparatus, the device, and the system involved in the present disclosure are merely exemplary examples and are not intended to require or imply that the equipment, the apparatus, the device, and the system must be connected, arranged, and configured in the manners shown in the block diagrams. It is recognized by a person skilled in the art that, the equipment, the apparatus, the device, and the system can be connected, arranged, and configured in an arbitrary manner.

The method and the apparatus in the present disclosure can be implemented in many ways. For example, the method and the apparatus in the present disclosure can be implemented by software, hardware, firmware, or any combination of the software, the hardware, and the firmware. The foregoing sequence of the steps of the method is for illustration only, and the steps of the method in the present disclosure are not limited to the sequence specifically described above, unless otherwise specifically stated in any other manner. In addition, in some embodiments, the present disclosure can also be implemented as programs recorded in a recording medium. These programs include machine-readable instructions for implementing the method according to the present disclosure. Therefore, the present disclosure further relates to a recording medium storing a program for implementing the method according to the present disclosure.

It should be further pointed out that, various components or various steps in the apparatus, the device, and the method of the present disclosure are decomposable and/or recombinable. These decompositions and/or recombinations shall be regarded as equivalent solutions of the present disclosure.

The foregoing description about the disclosed aspects is provided, so that the present disclosure can be arrived at or carried out by any person skilled in the art. Various modifications to these aspects are very obvious to a person skilled in the art. Moreover, general principles defined herein can be applicable to other aspects without departing from the scope of the present disclosure. Therefore, the present disclosure is not intended to be limited to the aspects illustrated herein, but to the widest scope consistent with the principles and novel features disclosed herein.

1. An audio-based processing method, including:
extracting a target acoustic source signal from a mixed audio signal collected through a microphone array;
recognizing text content corresponding to the target acoustic source signal from the target acoustic source signal;
determining a target loudspeaker based on the text content;
controlling the target loudspeaker to play a speech corresponding to the target acoustic source signal; and
performing echo cancellation for a loudspeaker in a sound region to which the target acoustic source signal belongs based on a position of the target loudspeaker, a position of the loudspeaker in the sound region to which the target acoustic source signal belongs, and a volume of speech for playback through the target loudspeaker.

2. The audio-based processing method according to claim 1, wherein the performing echo cancellation for the loudspeaker in the sound region to which the target acoustic source signal belongs based on the position of the target loudspeaker, the position of the loudspeaker in the sound region to which the target acoustic source signal belongs, and the volume of the speech includes:
acquiring a position of an auditory organ in a space of a person from who the target acoustic source signal is generated; and
performing echo cancellation for the loudspeaker in the sound region to which the target acoustic source signal belongs based on the position of the auditory organ in the space of the person from who the target acoustic source signal is generated, the position of the target loudspeaker, the position of the loudspeaker in the sound region to which the target acoustic source signal belongs, and the volume of the speech.

3. The audio-based processing method according to claim 1, wherein the extracting the target acoustic source signal from the mixed audio signal collected through the microphone array includes:
detecting whether there is a person sitting in each of seats in a vehicle; and
performing voice separation on the target audio signal based on a sound region to which a microphone corresponding to a seat occupied by a person belongs, and extracting the target acoustic source signal based on a voice separation result, wherein the microphone array includes microphones located at all seats in the vehicle.

4. The audio-based processing method according to claim 1, wherein the determining the target loudspeaker based on the text content includes:
extracting a keyword from the text content;
matching the keyword in the text content with a plurality of preset keywords; and
determining the target loudspeaker based on a matching result.

5. The audio-based processing method according to claim 4, wherein the matching the keyword in the text content with the plurality of preset keywords and determining the target loudspeaker based on a matching result includes:
establishing a correspondence relationship between at least two loudspeakers and the plurality of preset keywords, wherein the at least two loudspeakers include a loudspeaker corresponding to the sound region to which the target acoustic source signal belongs;
matching each keyword of the plurality of preset keywords with the keyword in the text content to obtain a matching result between the at least two loudspeakers and the text content; and
determining the target loudspeaker based on the matching result and the correspondence relationship.

6. The audio-based processing method according to claim 5, wherein the establishing the correspondence relationship between the at least two loudspeakers and the plurality of preset keywords includes:
establishing a first matching relationship between the at least two target seats and the plurality of preset keywords, and/or establishing a second matching relationship between persons in the at least two target seats and the plurality of keywords, wherein the at least two target seats are in one-to-one correspondence to the at least two loudspeakers; and
establishing the correspondence relationship between the at least two loudspeakers and the plurality of preset keywords based on the first matching relationship and/or the second matching relationship.

7. The audio-based processing method according to claim 1, further including:
when target-type audio is played through a specified loudspeaker, performing noise reduction for a remaining loudspeaker other than the specified loudspeaker based on a position of the specified loudspeaker, a position of the remaining loudspeaker, and a volume of target audio.

8. (canceled)

9. A computer readable storage medium, in which a computer program is stored, wherein the computer program is used for implementing an audio-based processing method including:
extracting a target acoustic source signal from a mixed audio signal collected through a microphone array;
recognizing text content corresponding to the target acoustic source signal from the target acoustic source signal;
determining a target loudspeaker based on the text content;
controlling the target loudspeaker to play a speech corresponding to the target acoustic source signal; and
performing echo cancellation for a loudspeaker in a sound region to which the target acoustic source signal belongs based on a position of the target loudspeaker, a position of the loudspeaker in the sound region to which the target acoustic source signal belongs, and a volume of speech for playback through the target loudspeaker.

10. An electronic device, wherein the electronic device includes:
a processor; and
a memory, configured to store a processor-executable instruction,
wherein the processor is configured to read the executable instruction from the memory, and execute the instruction to implement an audio-based processing method including:
extracting a target acoustic source signal from a mixed audio signal collected through a microphone array;
recognizing text content corresponding to the target acoustic source signal from the target acoustic source signal;
determining a target loudspeaker based on the text content;
controlling the target loudspeaker to play a speech corresponding to the target acoustic source signal; and
performing echo cancellation for a loudspeaker in a sound region to which the target acoustic source signal belongs based on a position of the target loudspeaker, a position of the loudspeaker in the sound region to which the target acoustic source signal belongs, and a volume of speech for playback through the target loudspeaker.

11. The electronic device according to claim 10, wherein the performing echo cancellation for the loudspeaker in the sound region to which the target acoustic source signal belongs based on the position of the target loudspeaker, the position of the loudspeaker in the sound region to which the target acoustic source signal belongs, and the volume of the speech includes:
acquiring a position of an auditory organ in a space of a person from who the target acoustic source signal is generated; and
performing echo cancellation for the loudspeaker in the sound region to which the target acoustic source signal belongs based on the position of the auditory organ in the space of the person from who the target acoustic source signal is generated, the position of the target loudspeaker, the position of the loudspeaker in the sound region to which the target acoustic source signal belongs, and the volume of the speech.

12. The electronic device according to claim 10, wherein the extracting the target acoustic source signal from the mixed audio signal collected through the microphone array includes:
detecting whether there is a person sitting in each of seats in a vehicle; and
performing voice separation on the target audio signal based on a sound region to which a microphone corresponding to a seat occupied by a person belongs, and extracting the target acoustic source signal based on a voice separation result, wherein the microphone array includes microphones located at all seats in the vehicle.

13. The electronic device according to claim 10, wherein the determining the target loudspeaker based on the text content includes:
extracting a keyword from the text content;
matching the keyword in the text content with a plurality of preset keywords; and
determining the target loudspeaker based on a matching result.

14. The electronic device according to claim 13, wherein the matching the keyword in the text content with the plurality of preset keywords and determining the target loudspeaker based on a matching result includes:
establishing a correspondence relationship between at least two loudspeakers and the plurality of preset keywords, wherein the at least two loudspeakers include a loudspeaker corresponding to the sound region to which the target acoustic source signal belongs;
matching each keyword of the plurality of preset keywords with the keyword in the text content to obtain a matching result between the at least two loudspeakers and the text content; and
determining the target loudspeaker based on the matching result and the correspondence relationship.

15. The electronic device according to claim 14, wherein the establishing the correspondence relationship between the at least two loudspeakers and the plurality of preset keywords includes:
establishing a first matching relationship between the at least two target seats and the plurality of preset keywords, and/or establishing a second matching relationship between persons in the at least two target seats and the plurality of keywords, wherein the at least two target seats are in one-to-one correspondence to the at least two loudspeakers; and
establishing the correspondence relationship between the at least two loudspeakers and the plurality of preset keywords based on the first matching relationship and/or the second matching relationship.

16. The electronic device according to claim 10, further including:
when target-type audio is played through a specified loudspeaker, performing noise reduction for a remaining loudspeaker other than the specified loudspeaker based on a position of the specified loudspeaker, a position of the remaining loudspeaker, and a volume of target audio.

17. The computer readable storage medium according to claim 9, wherein the performing echo cancellation for the loudspeaker in the sound region to which the target acoustic source signal belongs based on the position of the target loudspeaker, the position of the loudspeaker in the sound region to which the target acoustic source signal belongs, and the volume of the speech includes:
acquiring a position of an auditory organ in a space of a person from who the target acoustic source signal is generated; and
performing echo cancellation for the loudspeaker in the sound region to which the target acoustic source signal belongs based on the position of the auditory organ in the space of the person from who the target acoustic source signal is generated, the position of the target loudspeaker, the position of the loudspeaker in the sound region to which the target acoustic source signal belongs, and the volume of the speech.

18. The computer readable storage medium according to claim 9, wherein the extracting the target acoustic source signal from the mixed audio signal collected through the microphone array includes:
detecting whether there is a person sitting in each of seats in a vehicle; and
performing voice separation on the target audio signal based on a sound region to which a microphone corresponding to a seat occupied by a person belongs, and extracting the target acoustic source signal based on a voice separation result, wherein the microphone array includes microphones located at all seats in the vehicle.

19. The computer readable storage medium according to claim 9, wherein the determining the target loudspeaker based on the text content includes:
extracting a keyword from the text content;
matching the keyword in the text content with a plurality of preset keywords; and
determining the target loudspeaker based on a matching result.

20. The computer readable storage medium according to claim 19, wherein the matching the keyword in the text content with the plurality of preset keywords and determining the target loudspeaker based on a matching result includes:
establishing a correspondence relationship between at least two loudspeakers and the plurality of preset keywords, wherein the at least two loudspeakers include a loudspeaker corresponding to the sound region to which the target acoustic source signal belongs;
matching each keyword of the plurality of preset keywords with the keyword in the text content to obtain a matching result between the at least two loudspeakers and the text content; and
determining the target loudspeaker based on the matching result and the correspondence relationship.

21. The computer readable storage medium according to claim 9, further including:
when target-type audio is played through a specified loudspeaker, performing noise reduction for a remaining loudspeaker other than the specified loudspeaker based on a position of the specified loudspeaker, a position of the remaining loudspeaker, and a volume of target audio.
